(19) United States
(12) Patent Application Publication
(10) Pub. No.: US 2008/0120097 A1
(43) Pub. Date: May 22, 2008

(54) Apparatus and Method for Digital Coding of Sound

(76) Inventors: Guy Fleishman, Holon (IL); Alexander Weissman, Reshon Lezion (IL); Leonid Cherrnyak, Holon (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 10/599,421

(22) PCT Filed: Jan. 23, 2005
(86) PCT No.: PCT/IL05/00079

§ 371 Date: Sep. 28, 2006

Related U.S. Application Data
(60) Provisional application No. 60/557,381, filed on Mar. 30, 2004.

(51) Int. Cl. G10L 11/04

(52) U.S. Cl. 704/212; 704/E19.02

(57) ABSTRACT

The present invention discloses a method and a system for converting vocal sounds into digital data format. This technique will significantly decrease the amount of memory needed to store the digital data of the recorded voice. The system is comprised of a microphone converting the vocal sound signals into electrical signal, amplifying and filtering module for analyzing the electrical signals, a comparator module for comparing the analog signal to pre-defined value and sampling by clock edge module for representing the output signal of the comparator as a digital data format, a memory module for storing said digital data, a filtering module for reducing the alternating the analog signal higher harmonics, an amplifying module increasing the filtered signals amplitude and transducer module for converting the electrical amplifying signals into vocal sound signal.

### BACKGROUND OF THE INVENTION

The present invention relates to a vocal sound digital recording and more particularly, to voice digital recording in which there is no usage of A/D and D/A and further more, a substantial reduction in memory utilization. At present, there are several digital recording methods. This process, which varies due to hardware and designers, usually consists of several subsystems. The most common and general case of this process is called Pulse-Code Modulation (PCM). The system consists of several main components. Dither Generator, which generates random numbers for amplitudes to be added to the signal. There are many types of number generators which are mostly based on mathematical probability functions such as Gaussian, triangular, and rectangular functions. The produced numbers pass through a D/A converter and are added to the analog waveform to lessen distortion effects due to quantization of low level waves. The Anti-aliasing Filter which cuts off frequencies above the Nyquist frequency (half the sampling frequency) so that we do not get aliased frequencies. Sample-and-Hold Circuit samples the analog signal periodically, and holds the sampled value until the next sampling. The sampling theory is put into effect during the held period, and the A/D converter reads the value of the voltage, and converts it to a corresponding binary number, which is later, stored. Analog to Digital Converter converts the signal from an analog state to a digital state; the held input level representing the amplitude of the waveform is converted into a proportional binary quantization level. The Multiplexer simply combines audio streams from different channels into one stream. It takes digital words from each channel and interleaves them into a combined, alternating-stereo signal. The Processing and Error Correction unit add parity bits so that in the future we may see if the signal in fact has an odd or even number of ones. Interleaving is also introduced, whereby the bits are scattered about so that if a section does become corrupt, it will not affect an entire, solitary chunk of sound. Then the bits are being recorded on memory.

various measures have been taken for reducing the amount of digital data or information of original input sound signal waveform so that storage of the digital data can be effectively performed at low cost.

Another modulation that is being used mainly as a method of controlling power, but also in converting analog signal to digital signal (such as audio signals) without (significant) loss is called PWM. Pulse Width Modulation (PWM) refers to a method of carrying information on a train of pulses, the information being encoded it the width of the pulses.

A pulse-width modulated (PWM) signal or pulse duration modulated (PDM) signal is a square wave whose duty cycle is proportional to the instantaneous value of some continuous source signal. The PWM signal effectively applies discrete “on” and “off” signals for varying amounts of time. Pulse width modulation allows certain continuous time systems, such as a motor, to be controlled by a discrete signal. Many digital controllers have pulse width modulated outputs, so it would be cheaper to amplify the PWM signal from the controller than to use a D/A converter to convert this signal to a linear signal. Pulse width modulation works because many systems act as low pass filters, so as long as the period of the pulse width modulated signal is sufficiently small, only the DC component of the pulse width modulated signal will be seen at the output. Since most systems act as low-pass filters, we can drive a system with a PWM signal and expect the high frequency harmonics in the square wave to be filtered out while the lower frequencies (representing the modulated control signal) pass through as desired.

The simplest analog form of generating fixed frequency PWM is by comparison with a linear slope waveform such as a sawtooth. The output signal receives a high value when the sine wave is higher than the sawtooth. This is implemented using a comparator whose output voltage goes to HIGH (“1”) when the negative input is greater than the positive.

Regular sampled PWM makes the width of the pulse proportional to the value of the modulating signal at the beginning of the carrier period. For a sawtooth wave of frequency fs the samples are at 2 fs.

U.S Pat. No. 5,189,701 by Jain, disclose a method and apparatus for Voice coder/decoder. The pitch frequency of voice signals in successive time frames at a voice coder may be determined as by (1) Cepstrum analysis (time between successive peak amplitudes in each time frame), (2) harmonic gap analysis (amplitude differences between peaks and troughs of the peak amplitude signals in the frequency spectrum) (3) harmonic matching, (4) filtering of the frequency signals in successive pairs of time frames and the performance of (1)-(3) on the filtered signals to provide pitch interpolation on the first frame in the pair and (5) pitch matching. The amplitude and phase of the pitch frequency and harmonic signals are determined by refined techniques to provide amplitude and phase signals with enhanced resolution. Such amplitudes are simplified digitally by (a) taking the logarithm of the frequency signals, (b) selecting the signal with the peak amplitude, (c) offsetting the amplitudes of the logarithmic signals relative to such peak amplitude, (d) companding the offset signals, (e) reducing the number of harmonics to a particular limit by eliminating selective harmonics, (D taking a discrete cosine transform of the remaining signals and (g) digitizing the transformed signals. If the pitch frequency has a continuity within particular limits in successive time frames, the phase difference of the signals between successive time frames is provided. At a displaced voice decoder, the signal amplitudes are determined by performing, in order, the inverse of steps (g) through (a). These signals and the signals representing pitch frequency and phase are processed to recover the voice signals.

The present invention discloses a different and unique technique for coding/decoding voice signal without the use of A/D or D/A and without the need to code the signal's amplitude. The present invention also reduce the amount of memory bits, used to store the signal (8 times less than PWM), since the input signal's amplitude is not being sampled.

It is therefore an object of the present invention to provide a simple, effective and low-cost solution for digital recording of voice by reducing the amount of digital data of original input sound signal waveform and thus storing the digital data more effectively and at lower cost.

### THE OBJECT OF THE INVENTION

The object of the present invention is to provide a new method for recording vocal sound digitally. The proposed solution is simple, low cost and do not require conventional A/D, D/A, processor and compression software algorithm. This technique will significantly decrease the amount of memory needed to store the digital data of the recorded voice as well as other electrical components such as A/D and thus lowering the overall cost of the system.

### SUMMARY

The present invention discloses a method for converting vocal sounds into digital data format. Said method includes the following steps: amplifying and filtering the electrical signals, comparing the analog signal to pre-defined values by a comparator, sampling by clock the output signal of the comparator and representing the sampled signal by a digital data.

The digital data represents analog alternating signal that includes the vocal sounds harmonics. The method is further comprising of storing said digital data, wherein the vocal sounds are reconstructed from the stored digital data by applying the following steps: filtering alternating analog signal for reducing the signal higher harmonics, amplifying the filtered signals and transducing the electrical amplifying signals to vocal sound signal.

The present invention discloses a system for converting vocal sounds into digital data format, wherein the vocal sound signals are converted into electrical signal by the microphone. Said system comprised of amplifying and filtering module for analyzing the electrical signals, a comparator module for comparing the analog signal to pre-defined value and sampling by clock edge module for representing the output signal of the comparator as a digital data format. The system is further comprising of memory module for storing said digital data, filtering module for reducing the alternating the analog signal higher harmonics, amplifying module increasing the filtered signals amplitude and transducer module for converting the electrical amplifying signals into vocal sound signal.

The vocal sounds can be received from external memory sources, wherein said source stores a pre-recorded vocal sound on digital media. The system modules can also be software modules.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein-

FIG. 1 illustrates the spectrum of the glottal airflow.

FIG. 2 illustrates the use of an A/D (or D/A) converter to convert a continuous function (time-amplitude) to a discrete function (discrete time—discrete amplitude).

FIG. 3 illustrates the spectrum analysis of a square wave.

FIG. 4 illustrates the block diagram of the present invention.

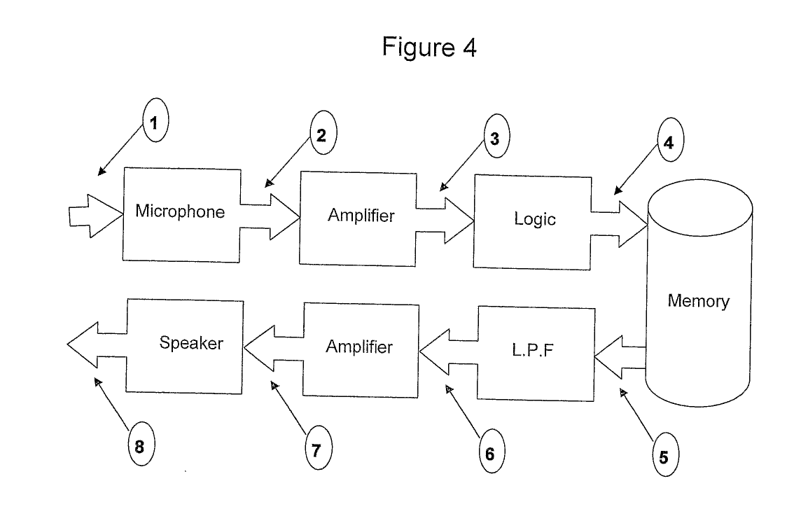

### DETAILED DESCRIPTION OF THE INVENTION

The present invention proposes new configuration and method for digital voice recording in a simple, easy and economic way.

### Introduction

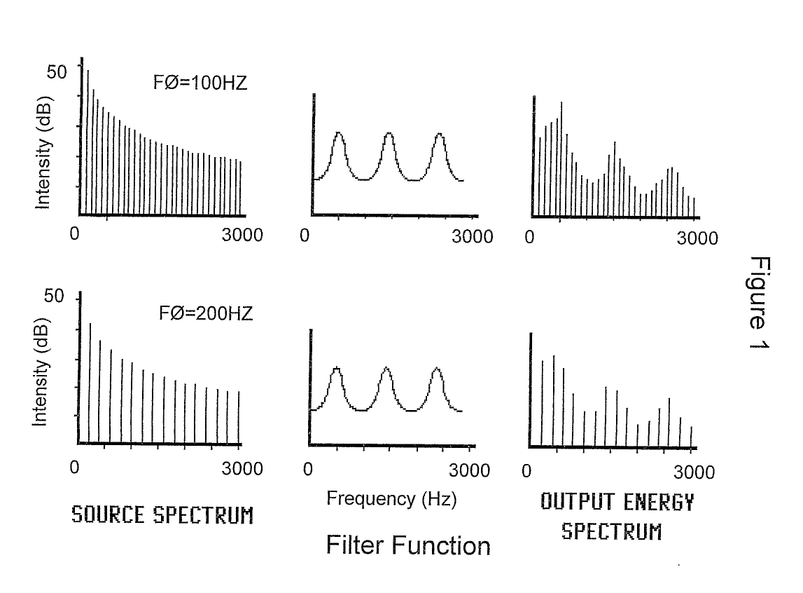

The vocal cords, the primary source of vocalized sounds, produce a tone with a fundamental frequency and a harmonic spectrum with many harmonics. The pressure level (amplitude) for the harmonics falls off 12 dB per octave. The spectrum of the glottal airflow, which has energy at the fundamental frequency and at the harmonics, is plotted at the top left of FIG. 1. The amplitude of the harmonics, which for the purposes of this figure combines the effects of both the source spectrum and radiation, decreases by approximately 6 dB per octave. At the top right of the figure is shown the spectrum that results from filtering the laryngeal source spectrum at the top left with the idealized filter function shown in the center of the figure. The laryngeal source has been “shaped” by the filter function. Energy is present at all harmonics of the fundamental frequency of the glottal source, but both the source amplitudes and the filter function determine the amplitudes of individual harmonics. The bottom half of FIG. 1 shows the effect of using a different source function, while retaining the same filter functions. In this case, the fundamental frequency of the glottal source is 200 Hz, with harmonics at integer multiples of the fundamental (400 Hz, 600 Hz, etc.). The effect of applying a filter to a signal is to modify the shape of the signal's spectrum. In the frequency domain, the effect of applying a filter to a signal is to multiply the spectrum of the signal by that of the filter. The result is a spectrum that combines the features of those of the input signal and the filter.

The spectrum of the glottal source is made up of a number of frequency spikes corresponding to the harmonics of the fundamental frequency of vibration of the vocal folds. The spectrum decreases in amplitude with increasing frequency at a rate of around 12 dB per octave that is for each doubling in frequency, the amplitude of the spectrum decreases by around 12 dB.

### Digital Recording Principles

Sound is converted to electrical current using a microphone. Continuous oscillations of air pressure become continuous oscillations of voltage in an electrical circuit.

If we represent the intensity of a sound by numbers proportionally related to the intensity, the analog value of the intensity has been represented digitally. The accuracy of the digital conversion depends upon the number of discrete numerical values that can be assigned and the rate at which these numerical measurements are made. For example, four numerical levels will represent changes in the amplitude of sound less accurately than 256 numerical levels and a rate of 8 conversions per second will be less accurate than a rate of 10,000 conversions per second. This number is called a sample and the whole conversion of sound to a series of numbers is called sampling.

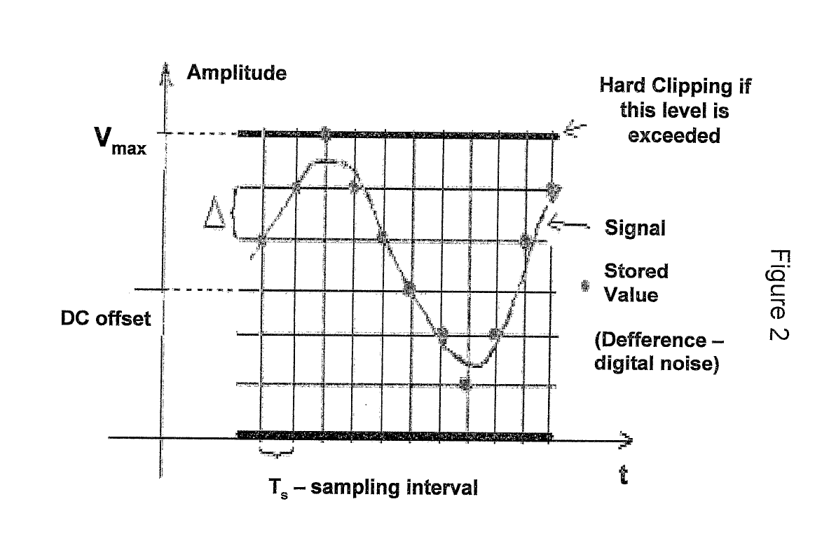

During digital recording of the analog signal, analog to digital (A/D) conversion takes place from continuous time-amplitude coordinates to discrete time-amplitude coordinates as illustrated in FIG. 2. The difference between the instantaneous analog signal and the digital representation is digital error.

The Nyquist theorem states that if a signal V (t) does not contain frequencies higher than f_{S}/2 (where f_{S}=1/T_{S}), then it can be fully recovered from its sampled values V (nTs) at discrete times tₙ=nT_{S} where n=. . . −1, 0, 1, 2, 3. The recovered signal will have all the frequencies in the range from 0 to f_{S}/2 Hz. The sampling rate or frequency per one second is 8000 for vocal sounds, and 44000 for music. It is required to provide 7 to 8 bits for vocal sounds, and 12 to 16 bits for music.

The Fourier transform transforms a time domain signal into a frequency domain representation of that signal. This means that it generates a description of the distribution of the energy in the signal as a function of frequency. This is normally displayed as a plot of frequency (x-axis) against amplitude (y-axis) called a spectrum.

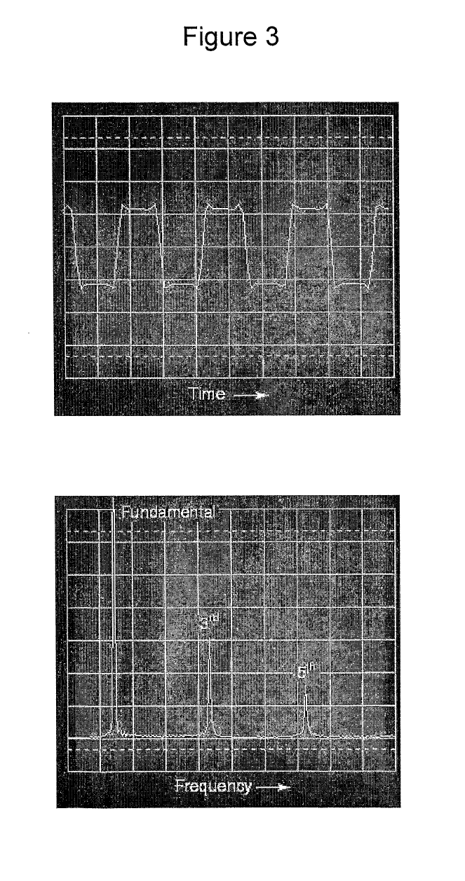

FIG. 3 displays the spectrum analysis of a square wave. According to the spectrum analysis, this waveform does not contain even harmonics, only infinitude of odd harmonics. Although this display does not show frequencies past the sixth harmonic, the pattern of odd-only harmonics in descending amplitude continues indefinitely.

The usual method of bringing analog inputs into a microprocessor is to use an analog to digital converter (A/D). Analog to digital converter (A/D) accepts an analog input, a voltage or a current, and converts it to a digital value that can be read by a microprocessor. A/D come in various speeds, uses different interfaces, and provide differing degrees of accuracy. The most common types of voice sampling A/D are successive approximation and sigma-delta. A successive approximation converter uses a comparator and counting logic to perform a conversion. The first step in the conversion is to see if the input is greater than half the reference voltage. If it is, the most significant bit (MSB) of the output is set. This value is then subtracted from the input, and the result is checked for one quarter of the reference voltage. This process continues until all the output bits have been set or reset.

A sigma-delta A/D uses a 1-bit D/A, filtering, and over sampling to achieve very accurate conversions. The conversion accuracy is controlled by the input reference and the input clock rate.

The primary advantage of a sigma-delta converter is high resolution. The flash and successive approximation A/Ds use a resistor ladder or resistor string. The primary disadvantage of the sigma-delta converter is speed. Because the converter works by over sampling the input, the conversion takes many clock cycles.

A/D operation is straightforward when a DC signal is being converted. But if the input signal varies by more than one least significant bit (LSB) during the conversion time, the A/D will produce an incorrect (or at least inaccurate) result. One way to reduce these errors is to place a low pass filter ahead of the A/D. The filter parameters are selected to ensure that the A/D input does not change by more than one LSB within a conversion cycle.

Another way to handle changing inputs is to add a sample-and-hold (S/H) circuit ahead of the A/D. The S/H circuit has an analog (solid state) switch with a control input, when the switch is closed, the input signal is connected to the hold capacitor and the output of the buffer follows the input. When the switch is open, the input is disconnected from the capacitor.

The ability of an S/H circuit to maintain the output in hold mode is dependent on the quality of the hold capacitor, the characteristics of the buffer amplifier (primarily input impedance), and the quality of the sample/hold switch (real electronic switches have some leakage when open). The amount of drift exhibited by the output when in hold mode is called the droop rate, and is specified in mill volt per second, mill volt per microsecond, or microvolt per microsecond.

Over the past decade, huge advances have been made in the area of audio coding for bit reduced transmission. Fast, effective perceptual audio coders like MPEG Layer 3 and MPEG-2 AAC (Advanced Audio Coding) have been proven to deliver studio quality audio with little or no perceptual loss, at bit rates as low as 64 Kbps (over digital transmission paths such as satellite and ISDN networks). Advanced Perceptual Audio Coding techniques (like MPEG Layer-3 or MPEG-2 MC) exploit the properties of the human perceptual system by eliminating audio frequencies and tones that are “masked” by other tones to achieve transmission of audio with almost perceptible loss of quality, often reducing the size of transmitted audio data by as much as 12 times. This makes such schemes perfect for high quality low bit-rate applications, like remote ISDN broadcasting, soundtracks for CD-ROM games, solid-state sound memories, Internet audio, digital audio broadcasting systems, and other similar applications.

### The Present Invention

The present invention differs from other digital recorders in the components, coding and the reconstruction method. The present invention does not require A/D, D/A, processor and compression algorithm. It also does not measure or code the amplitude level of the input signal samples. The system is comprised of a microphone, which converts the acoustic signal to an electronic one, an amplifier that amplifies the electrical signal, a filter (Low pass filter or Band pass filter), a logic comparator, sampling, control hardware and a memory (FIFO register).

FIG. 5 illustrates the signal path from the vocal (sound) signal to the digital storage in the memory (FIFO) and up to the retrieval of stored sound information and output audio The vocal (sound) signal (1) enters the microphone and is converted to electrical analog signal. The electrical signal (2) is then amplified, filtered and compared to predefined level (can be zero) by the comparator amplifier (or other type of comparing device). The comparator produces in its output a signal alternating between “0” and “1” levels (this signal include original voice signal harmonics) (3) according to its input. The alternating signal is being sampled by clock at a rate higher then twice the maximum frequency of the vocal sound signal (Nyquist theorem) and is now represented (4) as a digital signal (0's and 1's), thus eliminating the need for compressing algorithm. The system reduces the amount of memory bits, used to store the signal (8 times less than PWM), since the input signal's amplitude is not being sampled. The digital data is stored in the memory (5) in a more efficient and less consuming manner. The digital data stored represents the alternating signal that comprises of the original voice signal harmonics. In the process of retrieving the stored digital data (5) from the memory (FIFO), the data is being retrieved one bit at a time in a serial manner. The collection of bits retrieved, construct a pulse signal similar to the output of the comparator found at the beginning of the process chain. The data is being filtered by a Low pass or Band pass filter to extract the original signal harmonics. The filter reduces the amplitude of the high frequency components and creates the spectrums shape of the glottal airflow, which has energy at the fundamental frequency and the harmonics falls off 12 dB per octave (6).

The electrical analog signal is now being represented as a column of harmonics while the amplitudes of the harmonics are descending as their frequencies are ascending (This process eliminate the need for measuring and preserving the amplitude of the harmonies of the analog signals). The electrical analog signal is being amplified (7) and converted back to sound signal by electronic transducer (e.g. speaker) (8).

The present invention can connect to different types of input interfaces for receiving vocal sound signal from different sources. The source can be a pre-recorded vocal sound, found on digital media such as a memory bank, a computer and any other source that uses a digital representation of data. The present invention includes two main devices. The first device is comprised of a microphone, an amplifier, a filter (Low pass filter or Band pass filter), a logic comparator and sampling. The main function of this device is to represent the vocal signal as a digital one. This device (coding) can also be implemented as a software algorithm. The second device is comprised of a memory device, a filter (Low pass filter or Band pass filter), an amplifier and a transducer (speaker). This device is responsible for storing the digital data, decoding it and reproduces the vocal signal.

Both devices are capable of functioning as separate and stand alone hardware or software units. The first device can function as a coding and compressing unit and the second one as a storing and reconstructing system (e.g. an electronic greeting card).

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method for converting vocal sounds into digital data format, said method comprising the steps of:
amplifying and filtering the analog electrical signal of received vocal sound;
comparing the analog electrical signal to pre-defined values by a comparator;
sampling by clock the output signal of the comparator,
representing the sampled signal by digital data, which includes the vocal sounds harmonics.

2. The method of claim 1 further comprising the step of storing said digital data.

3. The method of claim 1 wherein the vocal sounds are reconstructed from the stored digital data by applying the following steps:
filtering the alternating analog signal which represents the stored digital data for reducing the signal higher harmonics;
amplifying the filtered signals;
tranducing the electrical amplifying signals to vocal sound signal.

4. The method of claim 1 wherein the alternating signal is being sampled by clock edge according to Nyquist theorem.

5. The method of claim 1 wherein the vocal sounds are received from external memory sources, wherein said source stores a pre-recorded vocal sound on digital media.

6. A system for converting vocal sounds into digital data format, wherein the vocal sound signals are converted into electrical signal by the microphone, said system comprised of:
amplifying and filtering module for analyzing the electrical signals;
a comparator module for comparing the analog signal to pre-defined value;
sampling by clock edge module for representing the output signal of the comparator as a digital data format;

7. The system of claim 6 further comprising memory module for storing said digital data.

8. The system of claim 6 further enabling to reconstruct the vocal sounds from the stored digital data, comprised of the following reconstructing modules:
filtering module for reducing the higher harmonics of the alternating analog which represents the stored digital data;
amplifying module increasing the filtered signals amplitude;
transducer module for converting the electrical amplified signals into vocal sound signal

9. The system of claim 6 wherein the alternating signal is being sampled by clock edge according to Nyquist theorem.

10. The system of claim 6 wherein the system modules are integrated into single device.

11. The system of claim 8 wherein the system reconstruction modules are integrated into a separate device.

12. The system of claim 6 wherein the vocal sounds are received from external memory sources, wherein said source stores a pre-recorded vocal sound on digital media.

13. The system of claim 6 wherein the system modules are software modules.
